(19) United States
(12) Patent Application Publication
(10) Pub. No.: US 2026/0291283 A1
(43) Pub. Date: Sep. 24, 2026

(54) SYSTEM, METHOD, AND APPARATUS FOR INTERACTIVELY CHARGING A MOBILE DEVICE VIA INDUCTION

(71) Applicant: JEAN HELFENSTEIN, Los Angeles, CA (US)

(72) Inventor: JEAN HELFENSTEIN, Los Angeles, CA (US)

(21) Appl. No.: 19/083,000

(22) Filed: Mar. 18, 2025

(51) Int. Cl. H02J 50/00; H01M 10/44; H02J 7/00; H02J 7/34; H02J 50/10; H04B 5/79; H04M 1/72409; H04M 1/72427; H04M 1/72454

(52) U.S. Cl. CPC H02J 50/005; H01M 10/44; H02J 7/342; H02J 7/42; H02J 7/731; H02J 50/10; H04B 5/79; H04M 1/72409; H04M 1/72427; H04M 1/72454; H02J 2207/30; H04M 2203/252; H04M 2250/04

(57) ABSTRACT

A system for interactively charging a mobile device via induction includes a housing defining a body and a face. An inductive charger is disposed within the face portion of the housing, and is operative to support and supply charge to a mobile electronic device placed thereon. The mobile electronic device may have a software application stored in a memory that is operative to display an interactive and personalizable animation depicting facial features corresponding to the housing body. A near filed communication (NFC) tag can be embedded in the housing and configured to activate the software application when the mobile electronic device is within range of the NFC tag. The system may be further operative to facilitate artificial intelligence (AI) driven voice interactions between a user and the animation.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to power chargers for mobile electronic devices, such as smartphones and tablet computers. More particularly, the subject matter relates to an inductive charger and interactive interactive software applications downloaded to a mobile electronic device configured to coordinate with the inductive charger.

### BACKGROUND

Mobile electronic devices have become essential tools for communication, work, and entertainment, necessitating frequent and reliable charging solutions. Traditional wired charging methods, while effective, present several drawbacks, including the inconvenience of handling cables, susceptibility to wear and tear, and limitations in mobility during charging. In response to these issues, inductive charging technology has emerged as a more convenient alternative by enabling power transfer without physical connectors. Utilizing electromagnetic fields to transmit energy between a charging pad and a compatible device, inductive charging eliminates the need for direct contact with charging ports, reducing mechanical stress and prolonging device longevity.

Traditional wireless chargers provide power transfer but do not facilitate direct digital engagement. For example, U.S. Pat. No. 9,559,546 to Claudepierre teaches an inductive charger configured to support a charging device in an upright position; U.S. Pat. No. 8,629,654 to Partovi et al. describes a portable inductive power source; U.S. Pat. No. 10,110,048 to Loewen teaches an inductive electronic device charger having a retractable power cord and clip for improving the portability of the charger; and U.S. Pat. No. 12,199,454 to Kovacs teaches a magnetic mounting system that facilitates inductive charging. Still, as consumer electronics increasingly integrate wireless charging capabilities, there is a growing demand for advancements that enhance efficiency, compatibility, and user experience.

Thus, although various wireless chargers have been proposed, none of those in existence combine the characteristics of the present invention. Indeed, there remains a need for a wireless charger that facilitates a personalized and interactive user experience.

### SUMMARY

The present disclosure is directed to an interactive mobile device charging system, method, and apparatus that includes an inductive charger housing and a mobile electronic device configured with inductive charging capability. In certain embodiments of the system, the housing is embedded with an NFC tag. In such embodiments, when the mobile electronic device is detected within range of the housing, the NFC interaction triggers the mobile electronic device to display personalizeable animations related to the housing. Otherwise, the mobile electronic device may be operative to receive input from a user to do the same.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the system comprises at least a mobile electronic device associated with a user, and a housing operative to charge the mobile electronic device via induction. Moreover, the mobile device may be operative to execute computer-readable instructions stored in a mobile electronic device memory to generate a screen on a mobile electronic device display of an interactive and personalizable animation. Indeed, in some embodiments, the housing may comprise a body potion having at least a torso and at least one limb configured to resemble any animal, humanoid, or character, whether true to life or in the abstract.

The housing may further comprise a face portion embedded with the inductive charger and configured to support an inductive charging enabled mobile electronic device with a screen of such device facing outward therefrom, for instance, magnetically.

One of ordinary skill in the art will recognize that various types of inductive charging components, such as coils, are available in the marketplace, Accordingly, the type and/or configuration of inductive charging components embedded within the housing will not limit the scope of the invention.

With the mobile electronic device supported by a face portion of the housing, the interactive and personalizable animation may be configured to depict facial features at the mobile electronic device display which correspond to the housing body. These may include facial features, whether realistic or abstract, corresponding, for example only and not limitation, to a dog's facial features in the event that the housing is configured to resemble a dog, a cat's facial features in the event that the housing is configured to resemble a cat, a rabbit's facial features in the event that the housing is configured to resemble a rabbit, an alien character's facial features in the event that the housing is configured to resemble an alien, a princess's facial features in the event that the housing is configured to resemble a princess and so on without either limiting or departing from the invention.

In addition, the animation may be configured to depict accessories for the facial features, such as, for example only and not limitation, clothing, glasses, headwear, jewelry, tattoos, piercings, etc.

In some embodiments, the mobile electronic device may be operative to facilitate artificial intelligence (AI) driven voice interactions between a user of the mobile device and the animation.

In some embodiments, the housing may be embedded with an NFC tag capable of electronic communication with an NFC reader embedded within the mobile electronic device, such as in a mobile electronic device NFC module. Therefore, in some embodiments, the mobile electronic device may be operative to execute computer-readable instructions stored in memory to display the interactive and personalizable animation on its screen. The animation may be triggered automatically when the mobile electronic device NFC reader is detected within a predetermined range of the housing NFC tag.

In addition to the foregoing, the housing may also comprise means for receiving a power cord operative to provide power to the inductive charging circuit embedded in the housing. In some embodiments, the housing further comprises an internal battery operative to itself supply power to the inductive charger, enabled by an inductive charging circuit, wherein the means for receiving a power cord is further operative to charge the internal battery. Means for receiving a power cord may be embedded in the body portion of the housing.

In accordance with some embodiments, a method for interactively charging a mobile electronic device may comprise: providing a housing having a body portion, a face portion, an inductive charging circuit embedded in the face portion, and means for receiving a power cord operative to provide power to the inductive charging circuit.

As above, the face portion may be configured to magnetically support a mobile electronic device facing outward therefrom thereon; and the method may further comprise, by the mobile electronic device, executing computer-readable instructions stored in the memory to generate a screen on the mobile electronic device display of an interactive and personalizable animation depicting facial features corresponding to the housing

In some other embodiments, the method may still further comprise housing an NFC tag within the inductive charger housing body portion, the NFC tag comprising an integrated circuit chip including information associated with the housing; responsive to detecting that the NFC tag is within a predetermined range of the mobile electronic device, by the NFC reader, reading information associated with the housing, such as unique identifiers, metadata defining the housing's identity, and characteristics like the specific animal or humanoid form it represents, which enable the mobile application to personalize interactions accordingly; and by the mobile electronic device, executing computer-readable instructions stored in a memory of the mobile electronic device to generate the interactive and personalizable animation depicting, for instance, facial features corresponding to the housing on a screen of a display of the mobile electronic device.

It is contemplated that providing an interactive inductive charger according to the disclosure and claims provided below may enhance user engagement by integrating wireless charging with AI-driven interactions, improve the convenience of such interactions through seamless device authentication and power management, and create a multifunctional computer ecosystem that supports real-time communication and personalized user experiences.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows a front perspective view of an embodiment of the system for interactively charging a mobile device via induction.

FIG. 2 shows a rear perspective view of one embodiment of the system for interactively charging a mobile device via induction.

FIG. 3 shows an exploded view of one embodiment of the system for interactively charging a mobile device via induction.

FIG. 4 is a diagram showing a networked environment in which an exemplary embodiment of one aspect of the system for interactively charging a mobile device via induction is implemented.

FIG. 5 is a diagram of a mobile device in accordance with one embodiment of the system for interactively charging a mobile device via induction.

FIGS. 6 and 7 illustrate exemplary alternative embodiments of a mobile device user interface in accordance with some embodiments of the system for interactively charging a mobile device via induction.

FIG. 8 illustrates an alternative embodiment of mobile device user interface in accordance with some embodiments of the system for interactively charging a mobile device via induction.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

It will be understood by one of ordinary skill in the art that the present disclosure describes an electronic device that may be configured to perform actions either automatically or in response to manual user input. For the sake of brevity, the embodiments described herein primarily focus on the automatic operation. However, unless explicitly stated otherwise, the disclosed principles apply equally to embodiments in which user input initiates or influences the device's operation.

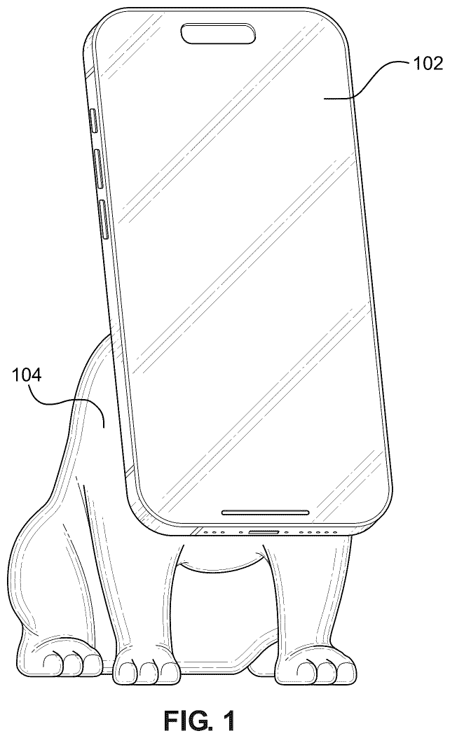

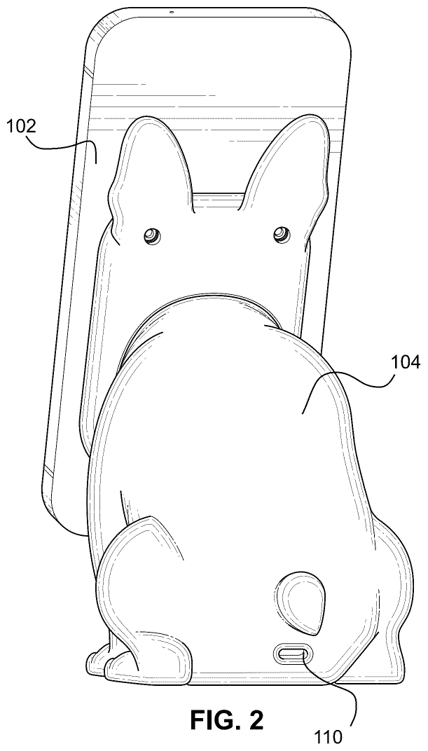

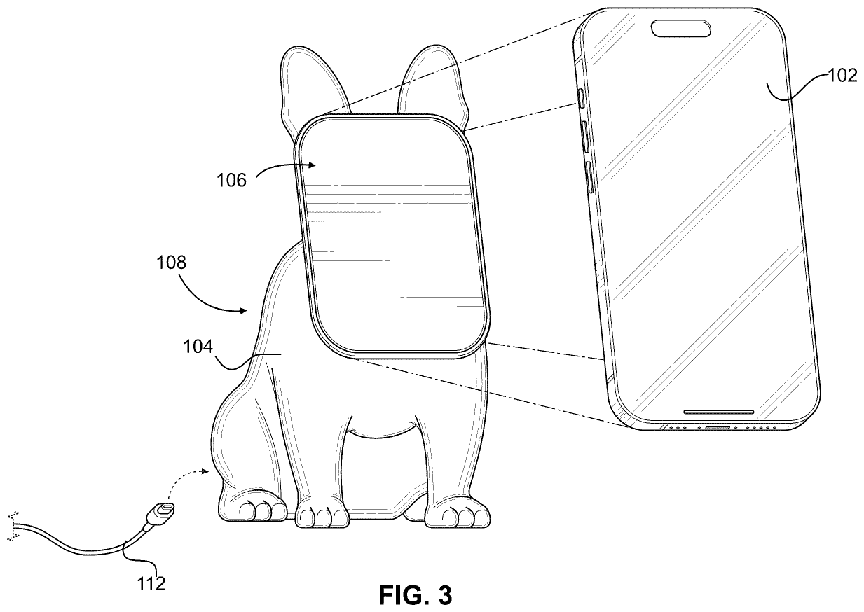

With reference to FIGS. 1 and 2 a mobile electronic device 102 is engaged with and charged via induction by housing 104. With particular attention to the view in FIG. 3, the housing may comprise a face portion 106 embedded with the inductive charger (obscured, but known to those of ordinary skill in the art) and configured to support inductive charging enabled mobile electronic device 102 thereon, for instance, magnetically. One of ordinary skill in the art will recognize that several such inductive chargers are available in the marketplace, and thus, the particular type and form of inductive charger embedded within the housing will not limit the invention.

A body potion 108 of the housing 104 may be configured to resemble any animal, humanoid, or character, whether true to life or in the abstract. In this case, the exemplary body portion 108 is configured to resemble the body of a French bulldog. However, this is for the purpose of providing a clarifying example only and not limitation. The body portion 108 may take any form as may be configured with interactive and personalizable facial features as desired.

In addition to the foregoing, the housing may also comprise means for receiving a power cord 112, such as charging port 110 shown in FIG. 2, operative to provide power to an inductive charging circuit embedded in the housing 104. In some embodiments, the housing further comprises an internal battery operative to itself supply power to the inductive charger, enabled by an inductive charging circuit, wherein the means for receiving a power cord is further operative to charge the internal battery. This is not shown in the figures but known to those of ordinary skill in the art. Means for receiving a power cord may be embedded in the body portion of the housing as depicted in FIG. 2, though the position of such means may change as desired or needed for functional, aesthetic, or other reasons.

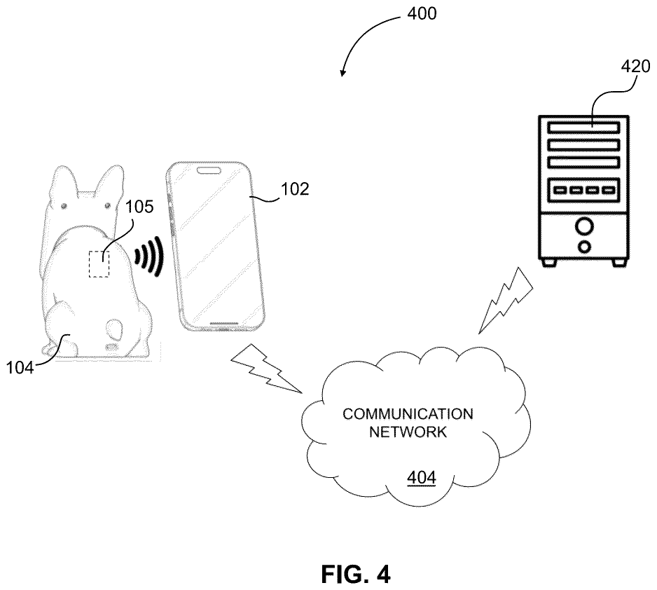

FIG. 4 depicts one exemplary embodiment of a networked environment in which an exemplary embodiment of the system for interactively charging a mobile device via induction 400 is implemented. As shown in FIG. 4, and by way of example only and not limitation the mobile device 102 is shown to interface with a communication network 404. The mobile device 102 may be embodied as a mobile computing device such as, for example and without limitation, a smartphone that incorporates cellular telephone functionality. Notably, the communications network can use one or more of various communications types such as, for example and without limitation, cellular and Wi-Fi communications.

A user of the mobile device 102 may use their device to access and engage with a mobile (or “software”) application hosted and processed by a network server 420. In some embodiments, a plurality of such mobile devices may be communicatively coupled to one another via the communication network 404 to become members of a social network that enables them to interact with each other using their mobile devices and exchange information pertinent to their inductive charger housing. In this exemplary embodiment, the social network may be facilitated by a mobile application that is hosted by social network server 420. As such, server 420 may facilitate interaction among a limited group of members, as may be established by the members themselves.

Additionally, server 420 implements certain aspects of the system for interactively charging a mobile device via induction and facilitates personalization of any features that may be displayed on the mobile device touch screen as well as interaction between the user and software application, including, for example, any AI-driven voice interactions.

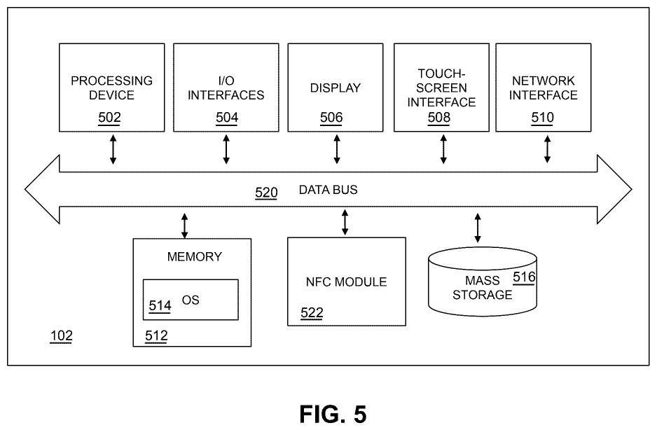

FIG. 5 comprises a block diagram of mobile device 102 shown in FIG. 4. As described earlier, mobile device 102 may be a smartphone or tablet computer but may also be embodied in any one of a wide variety of wired and/or wireless computing devices. As shown in FIG. 5, mobile device 102 includes a processing device (processor) 502, input/output interfaces 504, a display 506, a touchscreen interface 508, a network interface 510, a memory 512, and operating system 514, and a mass storage 516, with each communicating across a local data bus 520.

The processing device 502 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 512 can include any one of a combination of volatile memory elements (e.g., random-access memory (RAM, such as DRAM, and SRAM, etc.)) and nonvolatile memory elements. The memory typically comprises native operating system 514, one or more native applications, emulation systems, or emulated applications for any of a variety of operating systems and/or emulated hardware platforms, emulated operating systems, etc. For example, the applications may include application specific software which may comprise some or all the components of the mobile device 102. In accordance with such embodiments, the components are stored in memory and executed by the processing device.

An NFC module 522 may also communicate across bus 520 and may be operative to activate an interactive software application, as noted above and described in more detail below, resident in mobile device 102 memory, such as memory 512. Of course, the interactive software application may be activated as a result of user input instead, such as by manually tapping the mobile device touch screen.

One of ordinary skill in the art will be familiar with methods for operating an NFC tag as between the mobile device and inductive charger in accordance with the foregoing description and as depicted in FIG. 4. More particularly, this may comprise the steps of: housing the NFC tag 105 within the inductive charger housing 104, wherein an integrated circuit chip of the NFC tag includes information associated with the housing 104; reading the information associated with the housing using the NFC module 522 of FIG. 5; and executing instructions to activate a software application stored on the mobile device 102.

Near field communication in the various embodiments of the system, method, and apparatus for interactively charging a mobile device via induction may be effectuated in any suitable manner and form as known to those of ordinary skill in the art. For instance, the NFC module 522 may comprise an NFC antenna (alternatively, a coil or loop) embedded within the mobile device and operative to enable electromagnetic field communication as well as an NFC controller or chip within the mobile device operative to processing NFC signals. The housing NFC tag 105 as in FIG. 4, may comprise a passive chip embedded in a card, sticker, or other object which participates in short-range wireless data exchange via electromagnetic induction with the NFC antenna.

In particular, and as previously noted, the NFC tag 105 may be operative to activate a mobile software application downloaded to and stored in the memory 512 of the mobile device 102 when the mobile device 102 is within range of the NFC. The application may take any number of forms without departing from the invention and will be discussed in further detail below.

The coupling range will not limit the invention, and selecting a particular NFC tag to achieve a particular coupling range as desired or needed will not depart from the invention. For instance, the coverage of the NFC tag may be adjusted by integrating antenna coils of different sizes to best suit different applications. For instance, in embodiments where enhanced security or privacy is warranted or otherwise desired, such as embodiments in which the software application is operative to execute instructions for storing or otherwise relating to sensitive personal information, an NFC tag having a relatively shorter coupling range may be integrated into the housing. The coupling range may be, for instance only and not limitation, under about 5 inches, ensuring that a user mobile device is located quite close to the tag before activation of the software application occurs. However, it is also possible that an NFC tag may be configured to communicate with a corresponding NFC reader (the antenna, loop or coil) over a relatively greater distance. This may be desirable, for instance, where it may be necessary for wireless communication to effectively penetrate a relatively thick housing material or due to the characteristics of the housing material itself, which could be selected for practical, functional, or aesthetic reasons without departing from the invention.

Touchscreen interface 508 is configured to detect contact within the display area of the display 506 and provides such functionality as on-screen buttons, menus, keyboards, etc. that allows users to navigate user interfaces by touch. For some embodiments, the mobile device 102 will comprise GPS (not pictured, but known to those of ordinary skill in the art) or other means to determine the location of the mobile device 102.

One of ordinary skill in the art will appreciate that the memory 514 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 5, network interface device 510 comprises various components used to transmit and/or receive data over a networked environment such as depicted in FIG. 4. When elements of the system 400 are embodied as an application, the one or more components may be stored on a non-transitory computer-readable medium and executed by the processing device.

In some embodiments, the mobile electronic device 102 is operative to execute computer-readable instructions stored in the memory 512 to generate a screen on the mobile electronic device display 506 of an interactive and personalizable animation depicting facial features corresponding to the housing in response to detecting that the NFC tag is within a predetermined range of the mobile electronic device. In some embodiments, the mobile electronic device 102 is operative to facilitate artificial intelligence (AI) driven voice interactions between a user of the mobile device and the animation.

As further examples only, and not limitation, equipped with artificial intelligence (AI) driven voice assistant that is operative to respond to a custom wake word. In some embodiments, the mobile electronic device 102 may be configured to execute computer-readable instructions stored in the memory 512 to display customizable features and traits animating the “face” and facial expressions of the housing via the user's mobile electronic device 102, effectuating an interactive, character-based interface.

The system may be more generally configured to retains conversation history, support customizable personality traits, and synchronizes facial expressions with speech responses displayed on the smartphone screen or an external device. The system provides real-time notifications, including calendar reminders, social media alerts, weather updates, smart home interactions, and stock market tracking. Multilingual voice processing and two-way live speech translation are enabled via cloud-based or on-device processing. Embodiments of the NFC tag enable seamless device authentication, app launching, and retrieval of user preferences resulting in an engaging, intelligent, and interactive user experience and integrating AI functionalities with an animal, humanoid or other character interface.

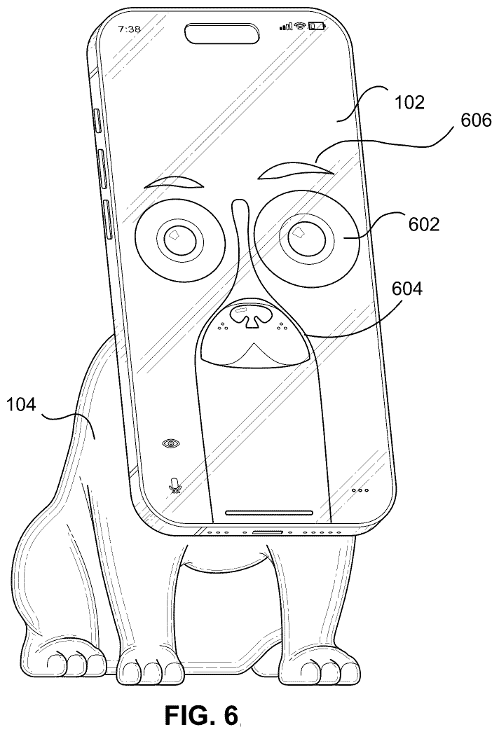

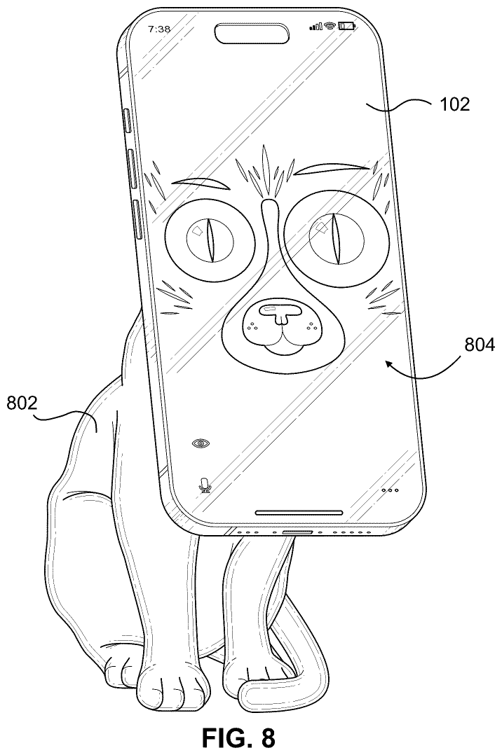

Turning to FIGS. 6 and 8, alternative, non-limiting exemplary embodiments of the invention are provided to further clarify the invention. With the mobile electronic device 102 supported by a face portion (obscured) of the housing, the interactive and personalizable animation displayed by the mobile electronic device 102 may be configured to depict facial features corresponding to the housing 104 in response to detecting that the mobile electronic device 102 NFC reader is within a predetermined range of the housing NFC tag (obscured). These may include facial features, whether realistic or abstract, corresponding, for example only and not limitation, to the exemplary French bulldog's features. In this exemplary embodiment, these include eyes 602 and a snout 604, as well as anthropomorphic eyebrows 606. Still, as one alternative example, FIG. 8 depicts a housing 802 configured to resemble a cat body. In such a case, the mobile electronic device 102 may be configured to display the interactive and personalizable animation comprising cat-like features 804.

It is to be understood that these are just two possible variations of body and animation pairings. Innumerable other combinations are possible provided that the facial animation is compatible with the system and functions as intended with the body.

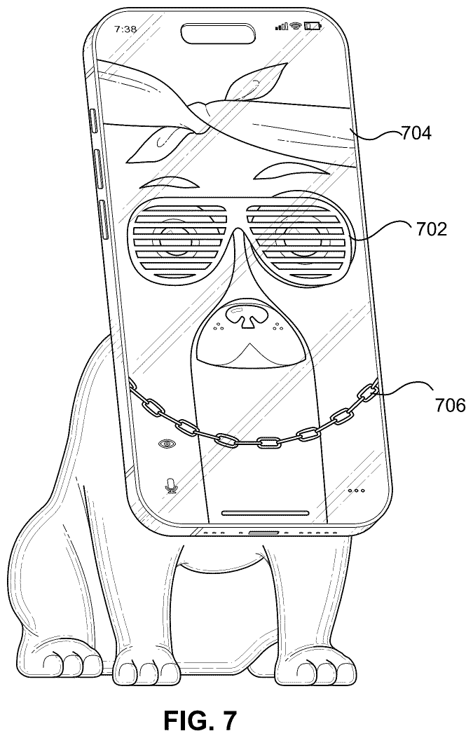

In addition, the animation may be configured to depict accessories for the facial features, such as those shown in exemplary FIG. 7. For example only and not limitation, clothing, and accessories such as the glasses 702, headwear 704, jewelry 706, depicted, although tattoos, piercings, and other features can be incorporated as well without departing from the invention. These accessories and clothing items may be selected and changed by the user for personalization, allowing for a unique and customizable experience. Such items may even be represented as non-fungible tokens, enabling users to own, trade, and collect digital fashion and accessories for their animated character. This enhances engagement, fosters creativity, and provides a sense of individuality in both virtual and real-world interactions.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. For example, the particular shape size, shape, material, color, or resemblance of the housing will not limit the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for interactively charging a mobile device via induction with which that terminology is associated. In general, the terms used in the following claims should not be constructed to limit the system, method, and apparatus for interactively charging a mobile device via induction to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method, and apparatus for interactively charging a mobile device via induction is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method, and apparatus for interactively charging a mobile device via induction.

What is claimed is:

1. A system, comprising:
a mobile electronic device comprising a processor, a memory, a network interface, a near field communication (NFC) reader, and a display, the processor being operatively coupled to the memory and the display;
a housing operative to interactively charge the mobile electronic device via induction, the housing having
a body portion;
a face portion configured to magnetically support an inductive charging enabled mobile electronic device thereon and having an inductive charging circuit embedded therein, the inductive charging circuit having a coil configured to provide power to the mobile electronic device via a pulsating magnetic field;
means for receiving a power cord operative to provide power to the inductive charging circuit embedded in the housing;
wherein the mobile device is operative to execute computer-readable instructions stored in the memory to generate a screen on the mobile electronic device display of an interactive and personalizable animation depicting facial features corresponding to the body portion of the housing.

2. The system of claim 1, wherein the body portion comprises an NFC tag embedded therein and the mobile device is operative to execute computer-readable instructions stored in the memory to generate a screen on the mobile electronic device display of an interactive and personalizable animation depicting facial features corresponding to the body portion of the housing in response to detecting that the NFC tag is within a predetermined range of the mobile electronic device.

3. The system of claim 1, the housing further comprising an internal battery operative to itself supply power to the inductive charging circuit, wherein the means for receiving a power cord is further operative to charge the internal battery.

4. The system of claim 1, wherein means for receiving a power cord is embedded in the body portion of the housing.

5. The system of claim 1, wherein the mobile electronic device is operative to facilitate artificial intelligence (AI) driven voice interactions between a user of the mobile device and the animation.

6. The system of claim 1, wherein the body portion corresponds to the shape of an animal body, humanoid body, or character body.

7. A method for interactively charging a mobile electronic device comprising a processor, a memory, a network interface, a near field communication (NFC) reader, and a display, the processor being operatively coupled to the memory and the display, the method comprising:
providing a housing having
a body portion having the NFC tag embedded therein;
a face portion configured to magnetically support a mobile electronic device thereon and having an inductive charging circuit embedded therein, the inductive charging circuit having a coil configured to provide power to the mobile electronic device via a pulsating magnetic field; and
means for receiving a power cord operative to provide power to the inductive charging circuit embedded in the housing; and
by the mobile electronic device, executing computer-readable instructions stored in the memory to generate a screen on the mobile electronic device display of an interactive and personalizable animation depicting facial features corresponding to the housing.

8. The method of claim 7, wherein the mobile electronic device is operative to facilitate artificial intelligence (AI) driven voice interactions between a user of the mobile device and the animation.

9. The method of claim 6, further comprising,
housing an NFC tag within the inductive charger housing, the NFC tag comprising an integrated circuit chip including information associated with the housing;
responsive to detecting that the NFC tag is within a predetermined range of the mobile electronic device, by the NFC reader, reading the information associated with the housing.

10. The method of claim 7, wherein the housing further comprises an internal battery operative to itself supply power to the inductive charging circuit, wherein the means for receiving a power cord is further operative to charge the internal battery.

11. The method of claim 10, wherein means for receiving a power cord is embedded in the body portion of the housing charger.

12. The system of claim 7, wherein the mobile electronic device is operative to facilitate artificial intelligence (AI) driven voice interactions between a user of the mobile device and the animation.

13. The method of claim 7, wherein the housing is configured in a shape resembling an animal body, humanoid body, or character body.

14. An inductive mobile electronic device charger, comprising:
a housing having
a body portion having a torso and at least one limb;
a face portion configured to magnetically support a mobile electronic device facing outward therefrom and having an inductive charging circuit embedded therein, the inductive charging circuit having a coil configured to provide power to the mobile electronic device via a pulsating magnetic field; and
means for receiving a power cord operative to provide power to the inductive charging circuit embedded in the housing.

15. The charger of claim 14, wherein the housing further comprises an internal battery operative to itself supply power to the inductive charging circuit, wherein the means for receiving a power cord is further operative to charge the internal battery.

16. The charger of claim 14, wherein means for receiving a power cord is embedded in the body portion of the housing.

17. The charger of claim 14, wherein the housing has an NFC tag embedded therein, and
wherein the NFC tag is a wireless chip configured to engage in electrical communication with a mobile electronic device and, when detected by an NFC reader embedded in the mobile electronic device within a predetermined range, is operative to activate a software application stored in a memory of the mobile electronic device and trigger the mobile electronic device to display content associated with the housing.

18. The charger of claim 17, wherein the NFC tag, when detected by the NFC reader of the mobile electronic device, launches a personalizable software application configured to facilitate AI-driven interactions.

19. The charger of claim 13, wherein the housing body is configured in a shape resembling an animal body, humanoid body, or character body.
